(19) United States
(12) Patent Application Publication
(10) Pub. No.: US 2010/0156082 A1
(43) Pub. Date: Jun. 24, 2010

(54) METHOD FOR MANUFACTURING A FRAME MEMBER FOR A VEHICLE, AND A FRAME MEMBER FOR A VEHICLE

(75) Inventors: Hans Adlersson, Askim (SE); Lena Larsson, Vastra Frolunda (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 12/600,263

(22) PCT Filed: Apr. 24, 2008
(86) PCT No.: PCT/SE08/00287

§ 371 Date: Nov. 15, 2009

(30) Foreign Application Priority Data
May 31, 2007 (SE) 0701342-8

(51) Int. Cl. B62D 21/02; B21D 53/88

(52) U.S. Cl. 280/798; 29/897.2

(57) ABSTRACT

A method for manufacturing at least one frame member for use as a support element in a vehicle frame includes providing a tubular element. According to the method, a pressure is applied in the interior of the tubular element while the tubular element is positioned at least partly inside a mould, thereby causing the tubular element to conform to the internal shape of said mould so as to change the longitudinal extension direction and/or cross-section of the tubular element in at least one position along the tubular element. A frame member is also provided.

### BACKGROUND AND SUMMARY

The invention relates to a method for manufacturing at least one frame member for use as a support element in a vehicle frame, said method comprising providing a tubular element.

The present invention also relates to a frame member for use as a support element in a vehicle frame, said frame member being formed from a tubular element.

In the field of heavy motor vehicles, such as load-carrying commercial vehicles in the form of trucks or semi-tractors or buses, it is common to design the vehicle with a frame arrangement comprising two longitudinally extending frame members. Each frame member is suitably in the form of a U-shaped beam element which forms a longitudinally extending support member for chassis components in the vehicle in question.

A general method of producing beam elements for automotive use is known from the patent document U.S. Pat. No. 7,073,259. This document teaches a method for so-called roll forming of beam elements having, for example, a square or rectangular cross-sectional shape.

The method disclosed in U.S. Pat. No. 7,073,259 is based on roll forming of a first profile element and then roll forming a second profile element which encloses the first profile element so as to form a closed profile beam. The method results in a beam having sufficient rigidity and strength in order to be used as a structural beam element in a vehicle.

In certain types of load-carrying vehicles it may be advantageous to shape the frame members with a varying shape and height. For example, the frame members can be shaped with tapered, i.e. gradually diminishing, end sections in order to be used in a semi-trailer wherein a coupling plate of a trailer unit can be arranged to slide onto the coupling plate. Another example is a frame arrangement in which each frame member is given a varying height along its longitudinal extension, in order to adapt the chassis to requirements regarding for example suitable wheel axle positioning, demands regarding a proper ground clearance of the vehicle and demands regarding the handling properties of the vehicle during operation. A third example is a frame arrangement having a cross-sectional design which for some other reason varies along the length of the frame member.

When providing a frame arrangement which is adapted to such design requirements, it is obvious that demands regarding strength and torsional rigidity also must be fulfilled.

To obtain the above-mentioned requirements, it is known to provide a frame arrangement wherein the cross-sectional dimensions and thickness of each frame member can be varied along its longitudinal extension. According to known technology, such a frame member can be designed with varying cross-sectional shape for example by cutting the frame member at suitable positions, then pressing or otherwise forming the various wall elements of the frame member in a suitable manner. Furthermore, the frame member is finalized by connecting its various wall elements for example by welding or by means of bolts, so that the desired design is obtained.

However, this method for producing such frame members is very costly and time-consuming, which obviously is a disadvantage.

With reference to the above, it can be noted that the beam elements which are manufactured by means of the method disclosed in U.S. Pat. No. 7,073,259 can be used in load-carrying vehicles. Furthermore, due to the need for beam elements having an adapted cross-sectional design, there is a need for alternative ways of producing such vehicle beam elements in a cost-effective and simple manner, while still maintaining a required strength and rigidity of the complete frame arrangement.

It is desirable to provide a frame member and a method for manufacturing a frame member in which the above-mentioned drawbacks can be overcome, in particular so as to manufacture a frame member in a cost-effective and simple manner.

According to an aspect of the present invention, a method of the type mentioned initially is provided which furthermore comprises applying a pressure in the interior of said tubular element while the tubular element is positioned at least partly inside a mould, thereby causing the tubular element to conform to the internal shape of said mould so as to change the longitudinal extension direction and/or cross-section of the tubular element in at least one position along the tubular element. The pressure applied is preferably in an interval 5-500 bar, more preferably 100-500 bar. Of course the requisite pressure to form the tubular element is dependent on several parameters such as the material in the tubular element, the geometry desired, etc. The pressure can be achieved by introducing a pressurized gas or liquid in the interior of the tubular element.

According to a preferred embodiment of the invention, after the forming step the method comprises splitting the tubular element along its longitudinal direction into pieces constituting two said frame members. Hereby, two frame members to be used for example as longitudinally arranged main frame rails for a truck can be produced in an effective way.

Traditionally such frame members for a truck are always produced individually by roll forming, pressing and/or welding a sheet to a beam or rail having a U-shaped cross section. Any further modifications of the beams will then be accomplished individually as well. By means of the invention, further modifications of the beams can be accomplished for two beams at the same time, i.e. the longitudinal extension direction and/or cross-section of the tubular element can be changed, and thereafter the tubular element is split into the both beams. In addition to the fact that the frame rails can be produced in an effective way, hereby it can also be ensured that both frame rails are formed in the same way. In other words; the rails can easily be formed as two mirror-inverted rails which in turn implies that a symmetric chassis based on the both longitudinally arranged main frame rails can be achieved.

According to an aspect of the present invention, a frame member of the kind mentioned initially is provided which is formed by applying a pressure in the interior of said tubular element while the tubular element is positioned at least partly inside a mould, said tubular element being conformed to the internal shape of said mould and formed so that the longitudinal extension direction and/or cross-section is changed in at least one position along the tubular element.

By means of aspects of the invention, a number of advantages are obtained. Firstly, it can be noted that frame members being manufactured in accordance with the invention can be formed without any costly and time-consuming welding and screwing operations for providing, for example, sections with different heights. Also, the invention allows manufacturing of frame members having various types of cross-sectional form modifications, such as local protrusions and cavities, for example for providing engine mount casings. The term “frame member” used herein is intended to comprise both longitudinally arranged load carrying frame rails as well as load carrying cross bars. The frame member according to the invention is preferably used as a support element in trucks or buses.

### BRIEF DESCRIPTION OF THE DRAWINGS

The invention will now be described in more detail with reference to a preferred exemplary embodiment and to the attached drawings, in which:

FIG. 1 is a schematic perspective view of a tubular element shown in an initial condition and being prepared so as to be used in accordance with the invention;

FIG. 2 is a schematic flow chart of one embodiment of the method according to the invention;

FIG. 3 is a schematic perspective view of the tubular element in FIG. 1, where the tubular element has been split into two frame members;

FIG. 4a shows in a simplified manner a step where a pressure P is to be applied inside the tubular element for forming a frame member according to the invention;

FIG. 4b shows the tubular element in a condition after the forming step in FIG. 4a;

FIG. 5 is a side view of a frame arrangement in a vehicle comprising frame members produced in accordance with the principles of the present invention;

FIG. 6a shows in a simplified manner a step where a pressure P is to be applied inside the tubular element for forming a frame member according to the invention using an alternative mould; and

FIG. 6b shows the tubular element in a condition after the forming step in FIG. 6a.

### DETAILED DESCRIPTION

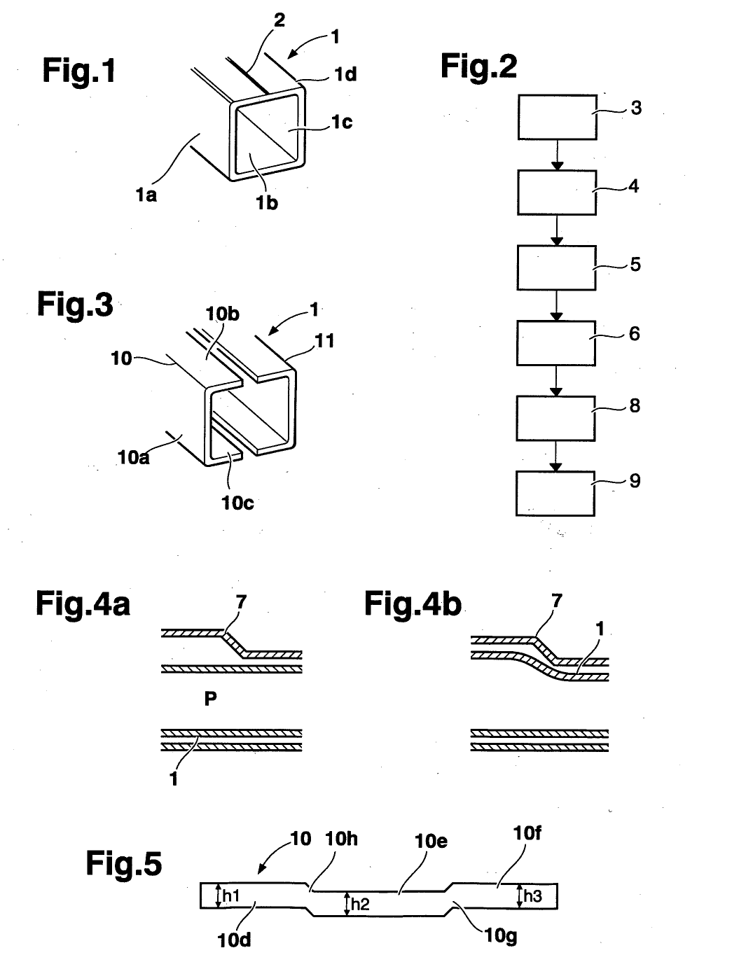

With reference to FIG. 1, there is shown a perspective view of a part of a tubular element 1, i.e. a generally elongated and hollow element having a particular cross-sectional form, for example square, rectangular or circular. The tubular element 1 shown in FIG. 1 is to be used to provide at least one frame member in a method in accordance with the invention. As previously known, and as mentioned initially, the tubular element 1 can be manufactured based on a coil of steel sheet material, which is suitably formed by means of a roll forming method. This is a method which is known per se from the patent document U.S. Pat. No. 7,073,259 and for this reason the roll forming method for producing the tubular element 1 is not described in greater detail here.

Preferably, the tubular element 1 is manufactured from high strength steel, which is a suitable material for use for vehicles frames. Most preferably, boron steel is used, since is has a strength and a yield limit (when hardened) which makes it particularly suitable for use within the automotive field. As shown in FIG. 1, the tubular element 1 can be formed with a generally square and closed cross-sectional shape, i.e. having four generally equally wide side walls 1a, 1b, 1c, 1d. In this manner, a cross-sectional design with a particular width and height is defined. However, the principles of the invention are not limited to such a design only, but can be used for producing tubular elements and frame members with other cross-sectional designs, for example rectangular, elliptical, circular or other types of regular or irregular shapes. Furthermore, the tubular element 1 is manufactured with a given length.

However, FIG. 1 only shows an end section of the tubular element 1, i.e. not its entire length.

In order to form a tubular element 1 according to FIG. 1, a sheet of steel can be roll-formed and welded together to a closed cross-sectional shaped. The welding is carried out so as to join the longitudinally extending edges of the tubular element 1 in order to obtain said closed form. In this manner, a weld line 2 is formed along one of the side walls 1d along the line where the edges of the steel sheet meet each other. Suitably, the weld line 2 is positioned along the longitudinal line of symmetry of the tubular element 1. As will be explained below in greater detail, the tubular element 1 will preferably be divided, i.e. split, along its length at a later process stage. In such a step, it will preferably be divided along the weld line 2.

It should be noted that the above-mentioned manner of producing the tubular element 1 by roll forming a sheet of steel is just one of several possible manufacturing methods. Other methods for forming the tubular element 1, for example by welding together different steel elements, are also possible within the scope of the invention.

The purpose of the invention is to provide a method for manufacturing frame members for a vehicle, suitably a vehicle in the form of a load-carrying vehicle, such as a truck or bus. Such a frame member is conventionally used in a longitudinally extending support structure for carrying various components forming part of the vehicle chassis. A frame arrangement for a vehicle chassis is well known, and for this reason it is not described in detail here.

The method according to the invention can comprise a number of steps, and the tubular element 1 as shown in FIG. 1 can constitute a starting point for such a manufacturing method. The method according to the invention will now be described with reference to a schematic flow chart shown in FIG. 2. As mentioned above, to provide the tubular element the process can start with a step in which a piece of sheet metal is roll-formed (reference numeral 3) to the shape of the tubular element 1 shown in FIG. 1, preferably with a closed cross-sectional shape. The next step can be that the tubular element 1 is cut to its proper length (reference numeral 4), i.e. a length which is suitable with regard to its use in a particular vehicle. This cutting operation is suitably carried out by means of plasma cutting or another suitable method.

The tubular element 1 is then preferably pre-heated (reference numeral 5) to a temperature at which it will be possible to modify its shape to the shape of a mould 7 (see FIGS. 4a and 4b) by applying a pressure P in the interior of the tubular element 1. For example an injection- or blow moulding method can be used. The pressure applied is preferably in the size of 5-500 bar, and more preferably 100-500 bar. If the tubular element 1 is manufactured from boron steel, an injection- or blow moulding can be carried out after pre-heating the tubular element 1 to a temperature of approximately 920° C. This means that after the pre-heating step 5, the tubular element 1 is subject to a pressure step (reference numeral 6) in which a highly pressurized gas (or liquid) is injected into the interior of the tubular element 1. Suitably, pressurized air is used for this step, and the pressure of the injected air is preferably in the magnitude of 300 bar.

The purpose of the injection of air is to modify or change the longitudinal extension direction and/or the cross-sectional dimensions and/or cross sectional shape of the tubular element 1 in accordance with the internal shape of the mould 7 enclosing the tubular element. To this end, the tubular element 1 is preferably first positioned at least partly inside the mould 7 as shown in FIG. 4a, which is a cross-sectional view along a certain section of the tubular element 1. When the tubular element 1 is in its pre-heated condition and the pressurized air is injected, the walls of the tubular element 1 will be expanded so as to conform to the internal shape of the mould 7, so as to change the longitudinal extension direction and/or cross-section of the tubular element 1 in one or more positions along the tubular element 1. In this manner, the tubular element 1 can be shaped with a cross-sectional form and/or size which varies along the longitudinal extension of the tubular element.

Generally, it can be noted that the shaping of the tubular element 1 by means of an applied increased pressure can be accomplished in other ways than by the above-mentioned injection- or blow moulding technique, i.e. in other ways than by applying an increased gas pressure. For example, the increased pressure can be accomplished by injecting a pressurized liquid such as water, i.e. instead of a gas.

With reference again to FIG. 2, the pressurizing step 6 is preferably followed by a hardening step (reference numeral 8) in which the tubular element 1 is quickly cooled. Suitably, this cooling is carried out by injecting water into the interior of the tubular element 1. Obviously, this causes the tubular element 1 to cool, thereby hardening the material of the tubular element 1. The resulting tubular element 1 of hardened boron steel has a yield limit of approximately 1100 MPa, which makes it particularly suitable for vehicle frame members.

After the cooling and hardening step 8, the tubular element 1 can be split into two halves, by means of a cutting operation (reference numeral 9) which, according to this embodiment is carried out along its entire length.

Through this step, two frame members 10, 11 are formed as illustrated in FIG. 3. Obviously, the frame members 10, 11 correspond to two halves of the tubular element 1. If the initial tubular element 1 has a square or rectangular cross-section, the frame members 10, 11 will be generally U-shaped beam elements, which is the conventional type of cross-sectional design for frame members in load-carrying vehicles. The tubular element can be formed and split into two parts having complementary design and/or into two mirror-inverted parts. Two mirror-inverted frame members can then be used as a left longitudinal frame rail and a right longitudinal frame rail, respectively, in a frame of a truck for instance.

As mentioned above, the cutting operation 9 of the tubular element 1 is preferably carried out along the exact position of the weld line 2 (cf. FIG. 1) so that no such weld line will be visible in any of the finished frame members 10, 11. This means that the final design of the first frame member 10 illustrated in FIG. 3 comprises a vertically arranged side wall 10a and two horizontally arranged flanges 10b, 10c. The side wall 10a consequently defines a web which connects the two flanges 10b, 10c.

FIG. 5 shows a side view of a typical frame member 10 to be used in a vehicle. The frame member is illustrated when being positioned horizontally, i.e. in the way the frame member is intended to be arranged when being installed in a vehicle. As mentioned initially, there are requirements for example for providing different heights and different cross-sectional shapes along the length of the frame member 10. Such variations may originate from requirements regarding the wheel axle positioning, regarding the desired ground clearance of the vehicle etc. For this reason, the present invention can be used to produce a frame member 10 having three different sections, shown as 10d, 10e, 10f, respectively, in FIG. 5. The arrangement with the three sections 10d, 10e, 10f is an example only; many different types of sections and other variations of the frame members are possible within the scope of the invention.

As an example only, the first section 10d has a first height h1, the second section has a second height h2, and the third section has a third height h3. All these heights can be chosen individually by forming the frame member 10 in accordance with the principles of the invention. Generally speaking, the height of a frame member in a load-carrying vehicle is of the magnitude 300 mm, but as explained, variations may occur in accordance with the invention. Furthermore, by using the mould 7 having suitable dimensions (cf. FIGS. 4a and 4b), the thickness of the walls of the frame member 10 along its length can also be varied. For example, the thickness of the walls of a frame member for a load-carrying vehicle is normally in the magnitude of 8 mm, but the present invention can be implemented so that the three sections 10d, 10e1 10f are given walls of different thicknesses.

As previously described, by the method according to the invention the longitudinal extension direction of the tubular element can be changed. The frame member illustrated in FIG. 5 changes direction in a first intermediate portion 10h and in a second intermediate portion 10g. The first 10h and second intermediate portions 10g are situated between the first 10d and second sections 10e, and between the second 10e and third sections 10f, respectively. As also previously described, by the method according to the invention the cross section of the tubular element can be changed. This implies that the shape and/or the size of the cross section of the tubular element can be changed. The sections 10d, 10e, 10f of the frame member illustrated in FIG. 5 have cross sections of different sizes (different heights h1, h2, h3).

According to known technology, the frame member 10 is then normally provided with punched holes and other treatments in order to serve as a part of a frame arrangement in a load-carrying vehicle.

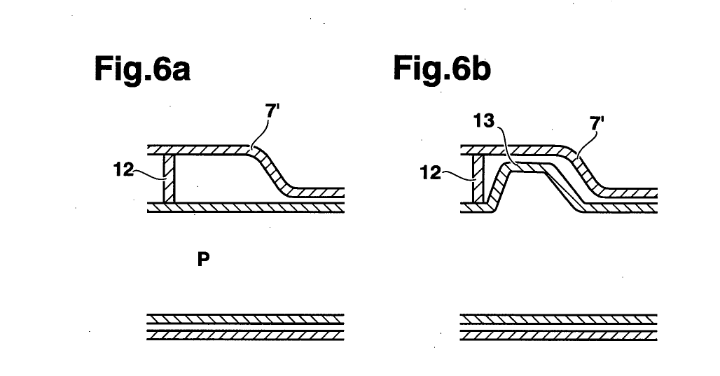

FIGS. 6a and 6b are simplified cross-sectional views generally corresponding to FIGS. 4a and 4b but showing an alternative mould 7′ for forming a frame member according to the invention. According to this alternative, the mould 7′ is used which is provided with an additional tool component 12 which is positioned between the inside of the mould 7′ and the outside of the tubular element 1. By suitable positioning of the tool component 12 and the design of the entire mould T, the tubular element 1 can be formed in a manner so that a local projecting element 13, i.e. a protrusion, is formed. This projecting element 13 can for example be dimensioned and positioned in a manner so that it serves as a holder or bracket for components to be mounted on the frame arrangement.

According to a further embodiment of the invention, the tubular element arrangement in question is only partially treated with the combined pre-heating, injection moulding and hardening steps as described above. For example, this embodiment can be implemented in a manner so that the entire tubular element is first subject to the pre-heating and injection moulding steps. However, and in contrast to the embodiment described above, one particular section of the tubular element (for example the front end section) is not hardened. The remaining part of the tubular element is hardened. When the tubular element has cooled, it is split all along its length as described above. After this cutting step has been carried out, the section which is not hardened can be shaped as desired according to known technology. Finally, this particular section is separately hardened.

The invention relates to a method for manufacturing vehicle frame members, to be used preferably as longitudinally extending supporting beam elements of the vehicle frame. The invention is based on the principle that a tubular element, i.e. a hollow and elongated element, having a closed cross-sectional design is arranged in a mould and subjected to a pressure P in the interior of the tubular element. The tubular element is preferably pre-heated before an increased pressure is applied. After an optionally hardening operation, the tubular element is preferably split into two halves, thereby forming two separate frame members. One purpose of the invention is to provide a method for forming one or more frame members in order to obtain a frame arrangement, which frame arrangement can extend along for example two different substantially horizontal planes when being installed in a vehicle. In FIG. 5 the tubular element has been shaped so that the frame member has a first portion 10d with a longitudinal extension in a first geometrical plane and a second portion 10e with a longitudinal extension in a second geometrical plane different from the first plane. In the embodiment illustrated in FIG. 5 the first and second planes are substantially parallel to each other, and the frame member is formed so that the first and second geometrical planes will constitute substantially horizontal planes when the frame member is installed in the intended position in a vehicle. Furthermore, the first 10d and second portions 10e have substantially the same longitudinally extension direction.

Additionally, the invention can also be used to obtain protrusions or recessed sections extending in a vertical or horizontal direction from the frame member. In this manner, there is provided a cost-effective and simple method for manufacturing frame members in vehicles which fulfil requirements regarding strength and rigidity in a vehicle environment. The invention can also be implemented to provide protrusions (or other similar components of the frame members) which may serve as holders or brackets for components to be mounted within a frame arrangement. This means that certain separate mounting brackets can be eliminated. Obviously, this saves weight and manufacturing cost for the complete vehicle.

The invention is not limited to the embodiment described above, but may be modified without departing from the scope of the claims below. For example, the invention can be used in different types of vehicles, for example load-carrying trucks. In principle, the invention can be implemented with a tubular element having a generally arbitrary cross-sectional form, not just a tubular element (cf. FIG. 1) having a square or rectangular cross-section. Also, it is possible to provide other types of protrusions or cavities by means of the injection moulding step.

The frame member can be manufactured from boron steel, as mentioned above, or from other types of steel, alloys or other material. Different types of steel can be used in order to manufacture different frame members with certain properties and suitable characteristics as regards strength for instance, depending on the use of each frame member.

1. A method for manufacturing at least one frame member (10, 11) for use as a support element in a vehicle frame, comprising:
providing a tubular element (1),
characterized by
applying a pressure in the interior of said tubular element (1) while the tubular element (1) is positioned at least partly inside a mould (7), thereby causing the tubular element (1) to conform to the internal shape of said mould (7) so as to change the longitudinal extension direction and/or cross-section of the tubular element (1) in at least one position along the tubular element (1).

2. Method according to claim 1,
characterized by splitting said formed tubular element (1) along its longitudinal direction into pieces constituting at least two said frame members (10, 11).

3. Method according to claim 1 or 2,
characterized by splitting said formed tubular element (1) into two parts having complementary design.

4. Method according to any of claims 1-3,
characterized by splitting said formed tubular element (1) into two mirror-inverted parts.

5. Method according to any of claims 1-4,
characterized by forming said tubular element (1) so that the tubular element has a first portion (10d) with a longitudinal extension in a first geometrical plane and a second portion (10e) with a longitudinal extension in a second geometrical plane different from the first plane.

6. Method according to claim 5,
characterized by that the first and second geometrical planes being substantially parallel to each other.

7. Method according to claim 6,
characterized by forming the first (10d) and second portions (10e) in the tubular element so that said first and second geometrical planes will constitute substantially horizontal planes when such a frame member is installed in the intended position in a vehicle.

8. Method according to any of claims 5-7,
characterized by that the first (10d) and second portions (10e) having substantially the same longitudinally extension direction.

9. Method according to any preceding claim,
characterized by forming said tubular element (1) with a material thickness which varies along the longitudinal extension of said tubular element (1).

10. Method according to any preceding claim,
characterized by forming at least one protrusion (13) on the tubular element which protrusion extends in a direction substantially transverse to the longitudinal direction of said tubular element (1).

11. A frame member (10, 11) for use as a support element in a vehicle frame, said frame member (10, 11) being formed from a tubular element (1),
characterized in that said frame member (10, 11) is formed by applying a pressure in the interior of said tubular element (1) while the tubular element (1) is positioned at least partly inside a mould (7), whereby said tubular element (1) being conformed to the internal shape of said mould (7) and formed so that the longitudinal extension direction and/or cross-section of the tubular element is changed in at least one position along the tubular element (1).

12. Frame member (10, 11) according to claim 11,
characterized in that the frame member is formed by splitting the tubular element (1) along its longitudinal direction so as to form two said frame members (10, 11).

13. Frame member (10, 11) according to claim 11 or 12,
characterized in that the frame member is constituted of one half of said tubular element (1) after splitting said tubular element (1) into two parts having complementary design.

14. Frame member (10, 11) according to any of claims 11-13,
characterized in that the frame member is constituted of one half of said tubular element (1) after splitting said tubular element (1) into two mirror-inverted parts.

15. Frame member (10, 11) according to any of claims 11-14,
characterized in that the frame member is formed so that it has a first portion (10d) with a longitudinal extension in a first geometrical plane and a second portion (10e) with a longitudinal extension in a second geometrical plane different from the first plane.

16. Frame member (10, 11) according to claim 15,
characterized in that the first and second planes are substantially parallel to each other.

17. Frame member (10, 11) according to claim 16,
characterized in that the frame member is formed so that the first and second geometrical planes will constitute substantially horizontal planes when the frame member is installed in the intended position in a vehicle.

18. Frame member (10, 11) according to any of claims 15-17,
characterized in that the first (10d) and second portions (10e) have substantially the same longitudinally extension direction.

19. Frame member (10, 11) according to any of claims 11-18,
characterized in that the frame member is formed with a material thickness which varies along its longitudinal extension.

20. Frame member (10, 11) according to any one of claims 11-19,
characterized in that the frame member is formed with at least one protrusion (13) which extends in a direction substantially transverse to the longitudinal direction of the frame member (1).

21. A vehicle comprising a frame member produced by the method according to any of claims 1-10.

22. A vehicle comprising a frame member according to any of claims 11-20.
